(19) United States
(12) Patent Application Publication
(10) Pub. No.: US 2021/0177680 A1
(43) Pub. Date: Jun. 17, 2021

(54) SELECTIVE AIR SEGMENT CONTROL FOR A PATIENT SUPPORT MATTRESS

(71) Applicant: Kreg Medical, Inc., Melrose Park, IL (US)

(72) Inventors: Craig Poulos, Wilmette, IL (US); Carlos Portillo, Chicago, IL (US); Tho Qg. Thieu, Chicago, IL (US)

(21) Appl. No.: 17/123,984

(22) Filed: Dec. 16, 2020

Related U.S. Application Data
(60) Provisional application No. 62/949,440, filed on Dec. 17, 2019.

(51) Int. Cl. A61G 7/057; A61G 7/07; A61G 7/018

(52) U.S. Cl. CPC A61G 7/05776; A61G 7/018; A61G 7/072

(57) ABSTRACT

A patient support mattress generally comprises one or more air segments/air cells/air sections/air bladders in a head portion of the patient support mattress and a selective air control mechanism connected to one or more adjacent individual air segments supporting a head portion of a body of a patient. The one or more adjacent individual air segments are located at the head portion of the patient support mattress. The selective air control mechanism selectively deflates and/or inflates the one or more adjacent individual air segments of the plurality of air segments.

### CROSS-REFERENCE TO RELATED APPLICATIONS

This application claims priority to U.S. Provisional Patent Application No. 62/949,440, filed Dec. 17, 2019, entitled Selective Air Bladder Control for a Patient Support Mattress, which is incorporated herein by reference in its entirety and made a part hereof.

### TECHNICAL FIELD

The present invention relates generally to a patient support surface/mattress, and more specifically to a selective air segment/air cell/air bladder control system for a patient support mattress for a patient.

### BACKGROUND

Hospital beds are well known in the art. While hospital beds according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

When patients lay prone on a bed for extended periods of time, a patient may be more susceptible to bed sores and other complications, especially in the head region of the patient's body. There is a need to selectively deflate portions of a mattress to provide a bridge and to help eliminate these potential bed sores and other complications for the patient. Specifically, there may be a need to selectively deflate and/or inflate horizontal air cells along a head or upper torso portion. These head or upper torso portion horizontal air cells may be, for example, located at a third position, fourth position, or fifth position along the mattress (starting from the head of the bed).

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of this disclosure may relate to a patient support mattress comprising a plurality of air segments at a head section of the patient support mattress that includes one or more individual horizontal air segments supporting a head portion of a body of a patient and an air control mechanism connected to the one or more individual horizontal air segments. The air control mechanism may selectively deflate and/or inflate each of the one or more individual air segments in the plurality of air segments.

In additional aspects of this disclosure, the one or more individual horizontal air segments may include a plurality of adjacent individual air segments. The plurality of adjacent individual air segments may include three adjacent individual air segments that are located at a third horizontal position, a fourth horizontal position, and a fifth horizontal position counting the plurality of air segments starting from the head portion of the patient support mattress. Each of the plurality of air segments may extend horizontally from a first side of the patient support mattress to an opposite second side of the patient support mattress. The air control mechanism may include one or more selector switches with each selector switch connected to one of the individual horizontal air segments to allow a user to manually selectively control inflating and deflating the individual horizontal air segments. The one or more selector switches may be rotational switches, rotating from a first position for inflating the individual horizontal air segments to a second position for deflating the individual horizontal air segments. The air control mechanism may include one or more air valve assemblies with each air valve assembly connected to one of the individual horizontal air segments to selectively control inflating and deflating the individual horizontal air segments. Each air valve assembly may include an air control valve, a valve spool to connect the air valve assembly to the individual horizontal air segments, and one or more o-rings to ensure a secure air connection between the air control mechanism and the individual horizontal air segments of the patient support mattress. The air control mechanism may include an electric air control system to electrically activate and deactivate the air control mechanism and provide selective air segment control for deflating and inflating the individual horizontal air segments of the patient support mattress. The electric air control system may include a remote control with a plurality of buttons to remotely activate and deactivate the air control mechanism and provide selective air segment control for deflating and inflating the individual horizontal air segments of the patient support mattress. The air control mechanism may include an air inlet supply port connected to the individual horizontal air segments, an air outlet port connected to an air control system that provides air to the plurality of air segments, and an air evacuation port.

Other aspects of this disclosure may relate to a patient support mattress comprising a plurality of air segments at a head section of the patient support mattress that includes three adjacent individual air segments supporting a head portion of a body of a patient and a selective air control mechanism connected to the three adjacent individual air segments of the plurality of air segments. The three adjacent individual air segments may extend horizontally across the patient support mattress, with a first individual air segment located at a third horizontal position, a second individual air segment located at a fourth horizontal position, and third individual air segment located at a fifth horizontal position counting the plurality of air segments starting from the head portion of the patient support mattress. The selective air control mechanism may include one or more selector switches with each selector switch connected to one of the adjacent individual air segments to manually selectively control inflating and/or deflating the three adjacent individual air segments.

Yet other aspects of this disclosure may relate to a patient support mattress comprising a plurality of air cells that includes three adjacent individual air cells located at a head portion of the patient support mattress on a patient bed and a selective air control mechanism connected to the three adjacent individual air cells. The three adjacent individual air cells may support a head portion of a body of a patient, with a first individual air cell located at a third horizontal position, a second individual air cell located at a fourth horizontal position, and third individual air cell located at a fifth horizontal position counting the plurality of air cells starting from the head portion of the patient support mattress. The selective air control mechanism may include an electric air control system with a plurality of buttons to electrically activate and deactivate the selective air control mechanism and provide selective air cell control for deflating and/or inflating the adjacent individual air cells of the patient support mattress.

### BRIEF DESCRIPTION OF THE DRAWINGS

To understand the present invention, it will now be described by way of example, with reference to the accompanying drawings in which:

FIGS. 1A, 1B, 1C, and 1D are perspective views of one embodiment of a selective air control mechanism for a patient support mattress in an inflated configuration in accordance with aspects of this invention.

FIGS. 2A, 2B, and 2C are perspective views of the selective air control mechanism for the patient support mattress with a covering in the inflated configuration in accordance with aspects of this invention.

FIGS. 3A and 3B are perspective views of the selective air control mechanism for the patient support mattress with one cell in a deflated configuration in accordance with aspects of this invention.

FIGS. 4A and 4B are perspective views of the selective air control mechanism for the patient support mattress with two cells in the deflated configuration in accordance with aspects of this invention.

FIGS. 5A and 5B are perspective views of the selective air control mechanism for the patient support mattress with three cells in the deflated configuration in accordance with aspects of this invention.

FIG. 6A is a perspective view of a selective air control mechanism with the patient support mattress in the inflated configuration in accordance with aspects of this invention.

FIG. 6B is a perspective view of the selective air control mechanism with the patient support mattress in the deflated configuration in accordance with aspects of this invention.

FIGS. 7A, 7B, 7C, 7D, and 7E are close-up views of an air manifold for the selective air control mechanism with the patient support mattress in accordance with aspects of this invention.

FIGS. 8A and 8B are front views of a front plate to the air manifold for the selective air control mechanism with the patient support mattress in accordance with aspects of this invention.

FIG. 8C is a back view of a back plate to the air manifold for the selective air control mechanism with the patient support mattress in accordance with aspects of this invention.

FIG. 9A is an exploded view of the air manifold for the selective air control mechanism with the patient support mattress in accordance with aspects of this invention.

FIG. 9B is an exploded view of one air valve of the air manifold for the selective air control mechanism with the patient support mattress in accordance with aspects of this invention.

FIGS. 10A, 10B, 10C, and 10D are various views of the air manifold for the selective air control mechanism with the patient support mattress in accordance with aspects of this invention.

FIG. 11A is an exploded view of one embodiment of a rotational low-air loss mattress for a patient support bed in accordance with aspects of this invention.

FIG. 11B is a perspective view of one embodiment of a low-air loss mattress section for a low-air loss mattress for a patient support bed in accordance with aspects of this invention.

FIG. 12 is a perspective view of one embodiment of a pump and manifold enclosure for a patient support bed in accordance with aspects of this invention.

FIG. 13 is a schematic of a valve configuration for one embodiment of a low-air loss mattress for a patient support bed in accordance with aspects of this invention.

FIG. 14 is a perspective view of one embodiment of a main air manifold and valve control system for a low air loss mattress for a patient support bed in accordance with aspects of this invention.

FIG. 15 is a cross-sectional view of the main air manifold and valve control system of FIG. 14 in accordance with aspects of this invention.

FIG. 16 is a perspective view of one embodiment of a CPR air manifold for a patient support bed in accordance with aspects of this invention.

Further, it is to be understood that the drawings may represent the scale of different components of one single embodiment; however, the disclosed embodiments are not limited to that particular scale.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

In various embodiments, a patient support surface or patient support mattress 100 may be provided on a patient support bed. Each bed may generally comprise one or more of the following: a base frame assembly, an intermediate frame assembly coupled to the base frame assembly, a weigh frame assembly coupled to the intermediate frame assembly, and a patient support assembly supported on the weigh frame assembly.

A bed may include a patient support assembly preferably comprises a support deck assembly and a mattress 100, however, either component may be identified as the patient support. The mattress 100 may be an air cell mattress, such as a closed air-cell mattress, inflatable mattress, low-air loss mattress, or rotation mattress or any other type of air cell mattress known in the art, including a mattress made of a combination of the aforementioned.

When patients lay prone on a bed for extended periods of time, a patient may be more susceptible to bed sores and other complications. There is a need to selectively deflate portions of a mattress to help eliminate these potential bed sores and other complications for the patient. Specifically, there may be a need to selectively deflate horizontal air cells along a head or upper torso portion. These head or upper torso portion horizontal air cells may be located, for example, at a third position, fourth position, or fifth position along the mattress (starting from the head of the bed). For example, the mattress may support the forehead of a patient laying in a proning position to bridge the gap between the forehead and the chin or other locations, such as supporting the trunk of the patient or supporting the upper thigh of the patient.

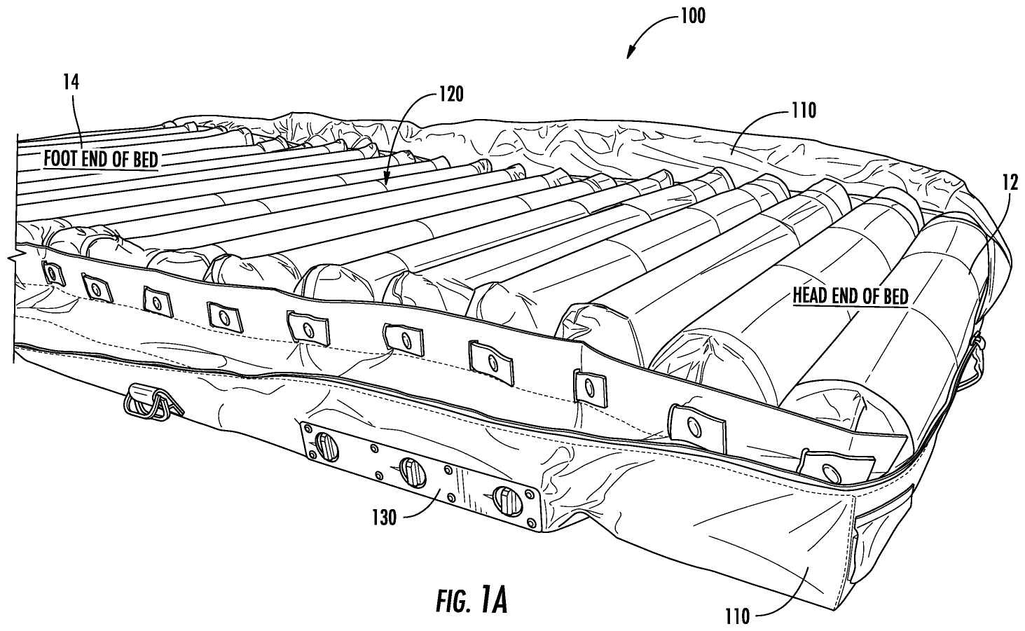

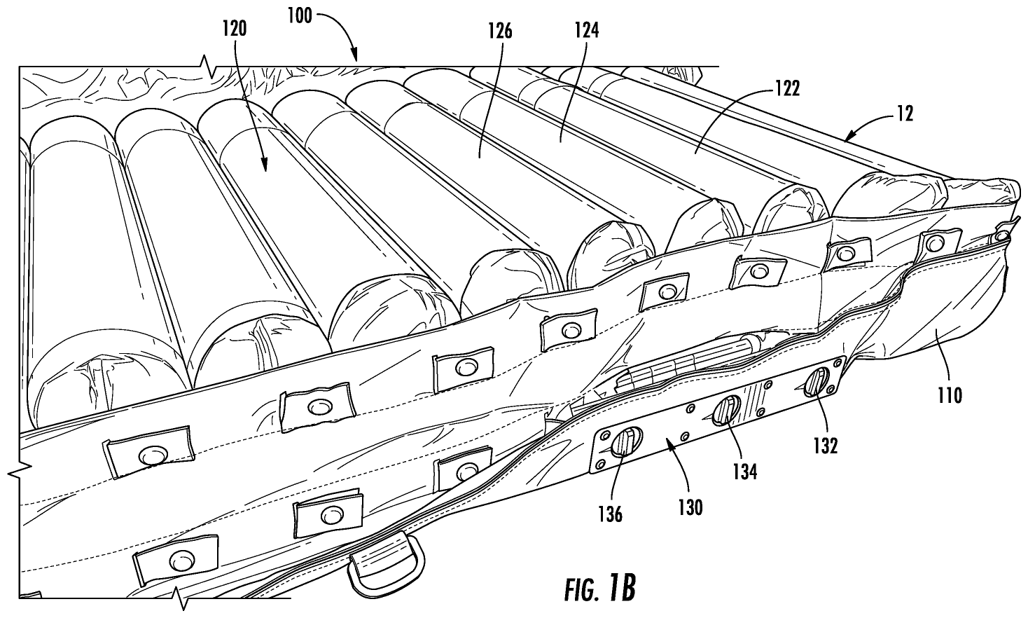

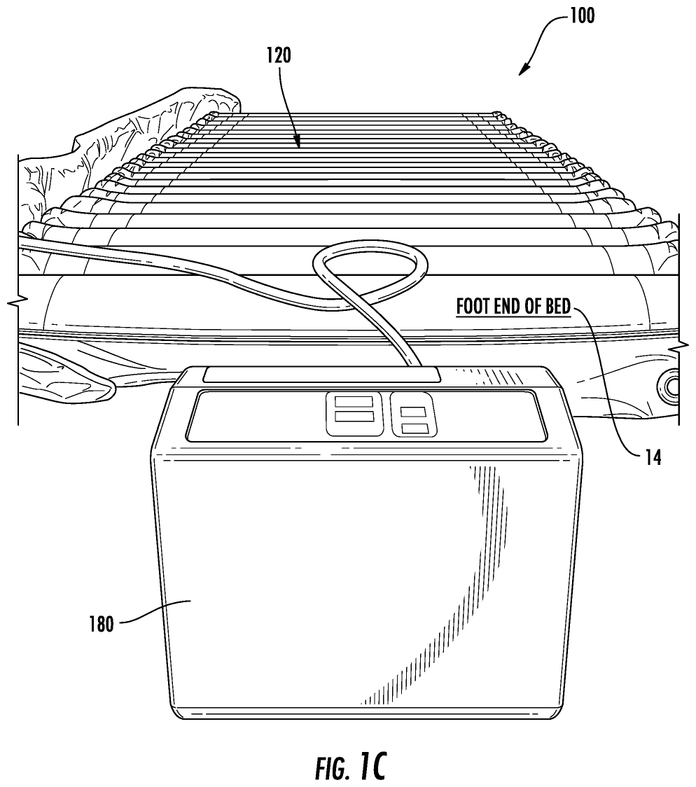

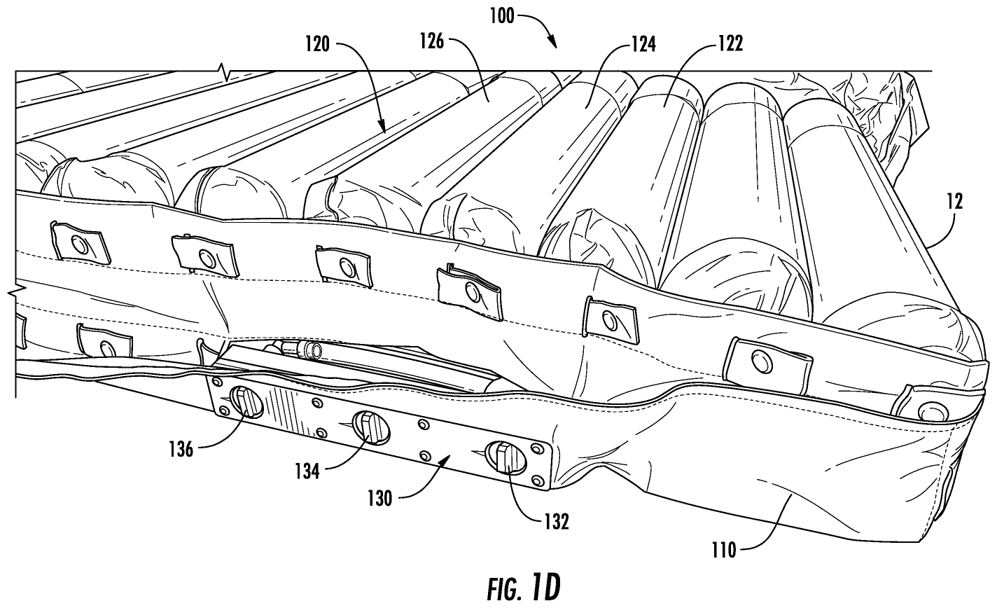

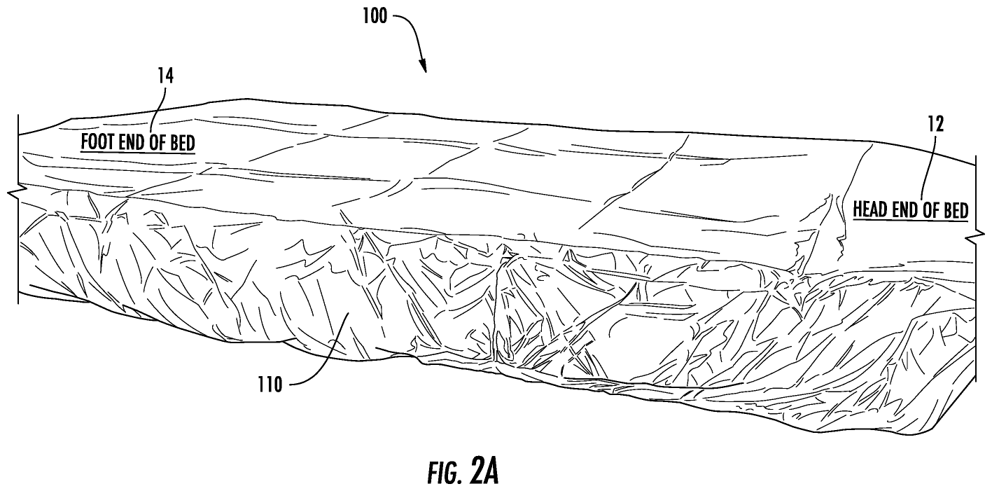

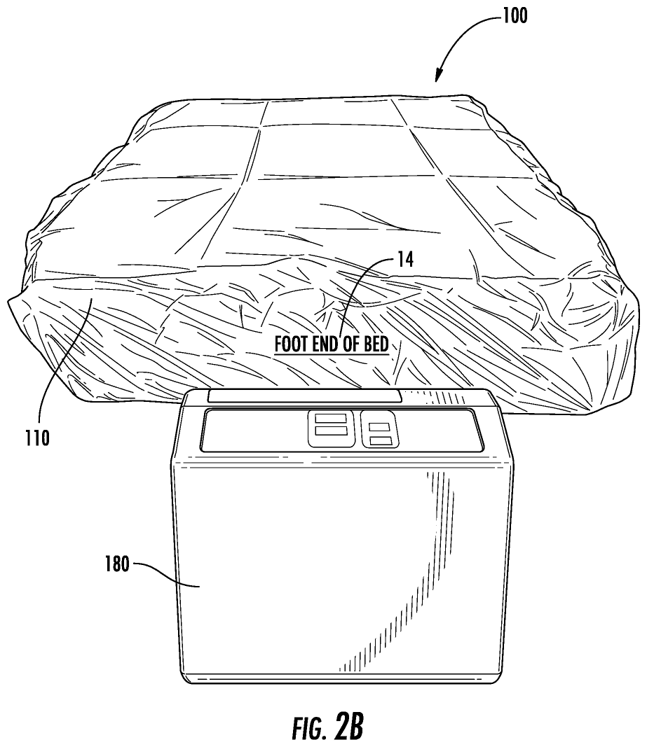

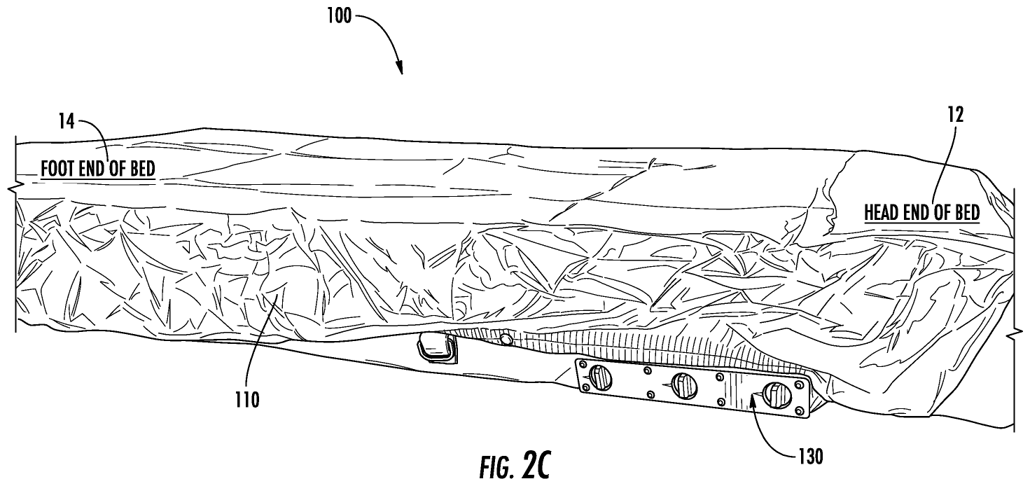

FIGS. 1A through 10D illustrate a selective air cell/air bladder control for a patient support mattress 100. The selective air cell/air bladder control for the patient support mattress 100 may allow users to manually deflate individual sections/air cells/air bladders 120 of the patient support mattress 100 selectively. The selective air cell/air bladder control for a patient support mattress 100 may also allow users to manually inflate individual sections/air cells/air bladders 120 of the patient support mattress 100 selectively. Specifically, FIGS. 1A, 1B, 1C, and 1D illustrate various views of the selective air cell for the patient support mattress 100 in an inflated configuration. FIGS. 2A, 2B, and 2C illustrate various perspective views of the selective air cell/air bladder control for the patient support mattress 100 with a mattress cover 110 in the inflated configuration.

Specifically, as illustrated in FIGS. 1A, 1B, and 1D, a patient support mattress 100 may include a plurality of air cells 120 that individually extend horizontally from a first side of the patient support mattress 100 to an opposite second side of the patient support mattress 100. Without departing from this invention, as known and used in the art, air cells 120 may include terms such as air sections, air segments, air bladders, and other such terms known and used in the art. Throughout the rest of this description, air cells 120 will be used to describe this feature. The group of plurality of air cells 120 may extend lengthwise along the bed and patient support mattress 100 from a head end 12 of the bed to a foot end 14 of the bed. The patient support mattress 100 may include any number of air cells 120. For example, as illustrated in the figures, the patient support mattress 100 may include approximately twenty individual air cells 120. There may be more or less than twenty individual air cells 120 without departing from this invention.

Additionally, the patient support mattress 100 may also include a selective air cell control mechanism 130. The selective air cell control mechanism 130 may be an air cell control assembly or an air manifold assembly without departing from this invention. The selective air cell control mechanism 130 may act as a selective air cell control panel to allow users to selectively deflate and bridge a section of the body of a patient on the patient support mattress 100. The selective air cell control mechanism 130 may include one or more of the following: an air manifold, air hoses, air valves, one-way valves, two-way valves, and/or other air control devices to selectively deflate and/or inflate one or more of the plurality of individual air cells 120. The selective air cell control mechanism 130 may be connected to one or more specific air cells from the plurality of individual air cells 120. In the exemplary illustration of the figures, the selective air cell control mechanism 130 may be connected to a third position air cell 122, a fourth position air cell 124, and a fifth position air cell 126. The third position air cell 122 may be the third individual air cell counting the air cells 120 by starting at the head end 12 of the bed. The fourth air cell 124 may be the fourth individual air cell counting the air cells 120 by starting at the head end 12 of the bed. The fifth air cell 126 may be the fifth individual air cell counting the air cells 120 by starting at the head end 12 of the bed. The selective air cell control mechanism 130 may be connected to various other positional air cells 120 throughout the entire length of the mattress 100 without departing from this invention. Additionally, the selective air cell control mechanism 130 may be connected to multiple or groups of air cells 120 without departing from this invention.

The selective air cell control mechanism 130 may include one or more selector switches that control one or more air cells. The one or more selector switches may include a first selector switch 132, a second selector switch 134, and a third selector switch 136. In the exemplary illustration of the figures, the first selector switch 132 may control the inflation and deflation of the third position air cell 122, the second selector switch 134 may control the inflation and deflation of the fourth position air cell 124, and the third selector switch 136 may control the inflation and deflation of the fifth position air cell 126.

Additionally, as illustrated in FIG. 1C, the patient support mattress 100 may also include an air controller 180. The air controller 180 may supply/provide air to the patient support mattress 100 and the plurality of air cells 120. The air controller 180 may be connected via air connections to the patient support mattress 100 and the air cells 120. The air controller 180 may also be connected via air connections to the selective air cell control mechanism 130.

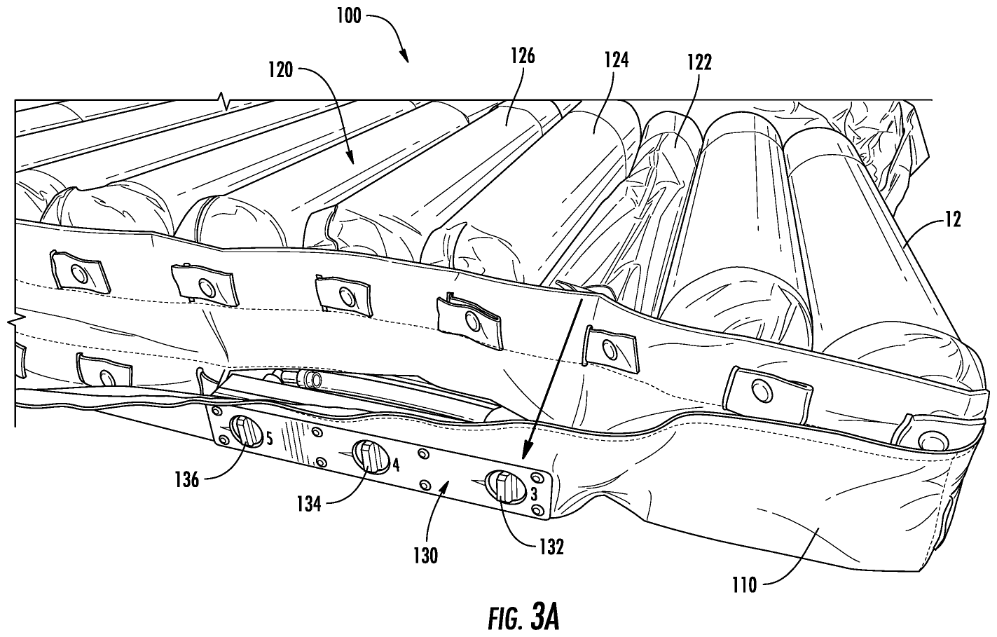

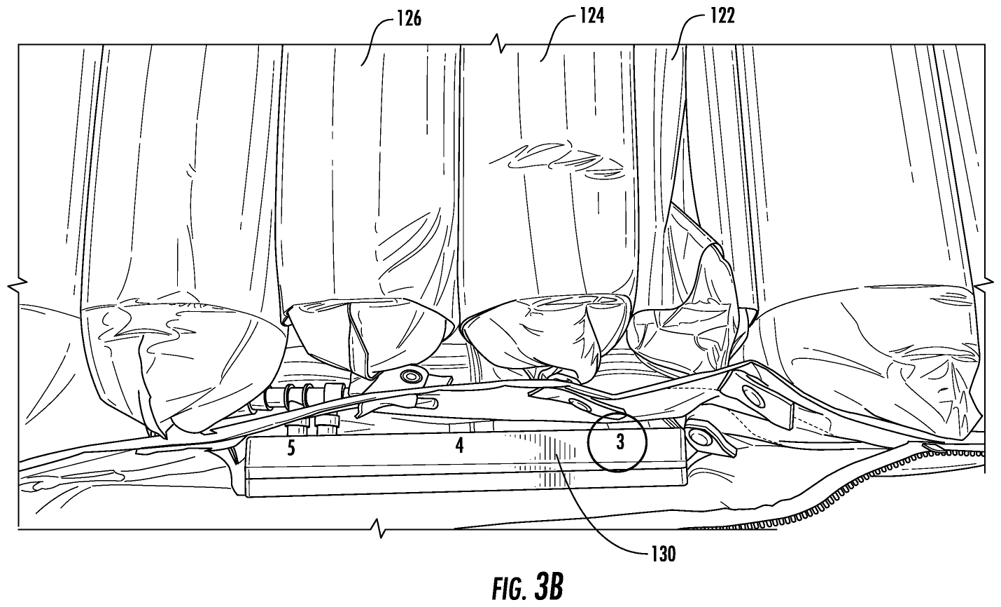

FIGS. 3A and 3B illustrate perspective views of the selective air cell control for the patient support mattress 100 with one air cell in a deflated configuration. Specifically, FIGS. 3A and 3B illustrate the third air cell 122 connected to the first selector switch 132 and the third air cell 122 in the deflated configuration with the first selector switch 132 of the selective air cell control mechanism 130 in the deflated position. Additionally, the fourth air cell 124 connected to the second selector switch 134 is in the inflated configuration with the second selector switch 134 of the selective air cell control mechanism 130 in the inflated position. Lastly, the fifth air cell 126 connected to the third selector switch 136 is in the inflated configuration with the third selector switch 136 of the selective air cell control mechanism 130 in the inflated position.

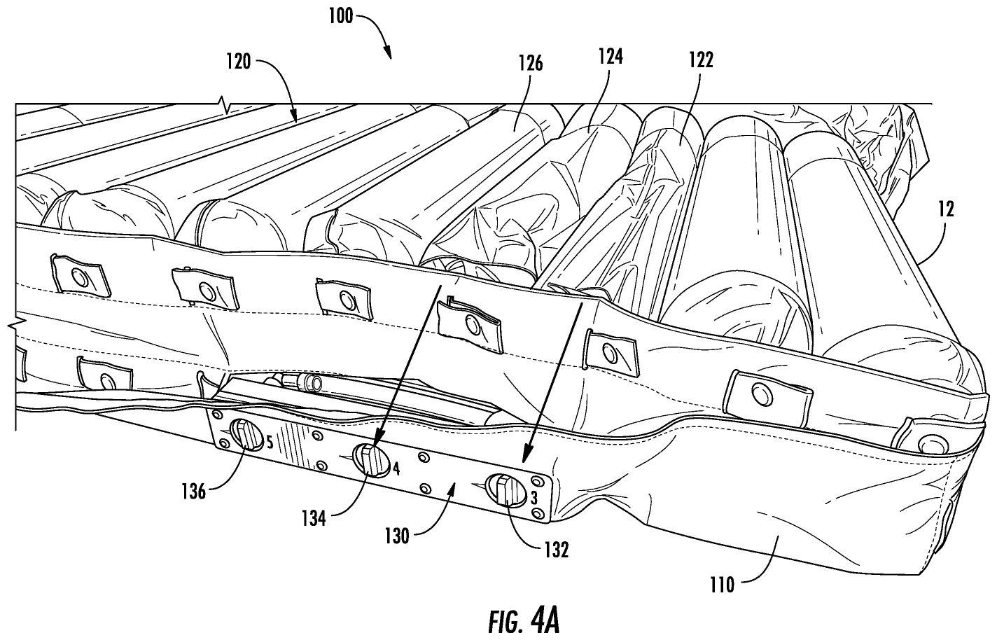

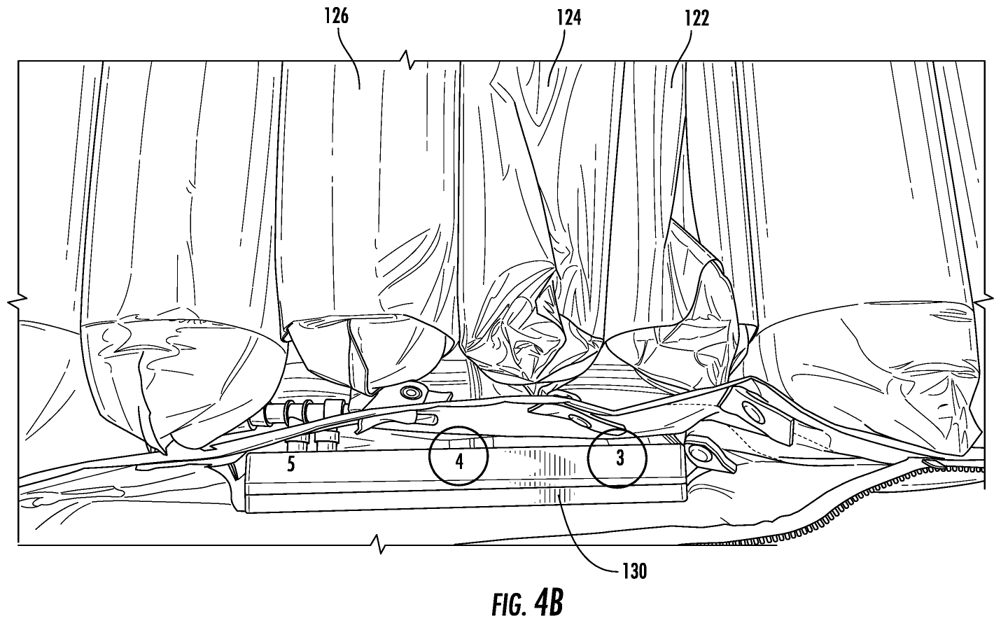

FIGS. 4A and 4B illustrate perspective views of the selective air cell control for the patient support mattress 100 with two air cells in the deflated configuration. Specifically, FIGS. 4A and 4B illustrate the third air cell 122 connected to the first selector switch 132 and the third air cell 122 in the deflated configuration with the first selector switch 132 of the selective air cell control mechanism 130 in the deflated position. Additionally, the fourth air cell 124 connected to the second selector switch 134 is in the deflated configuration with the second selector switch 134 of the selective air cell control mechanism 130 in the deflated position. Lastly, the fifth air cell 126 connected to the third selector switch 136 is in the inflated configuration with the third selector switch 136 of the selective air cell control mechanism 130 in the inflated position.

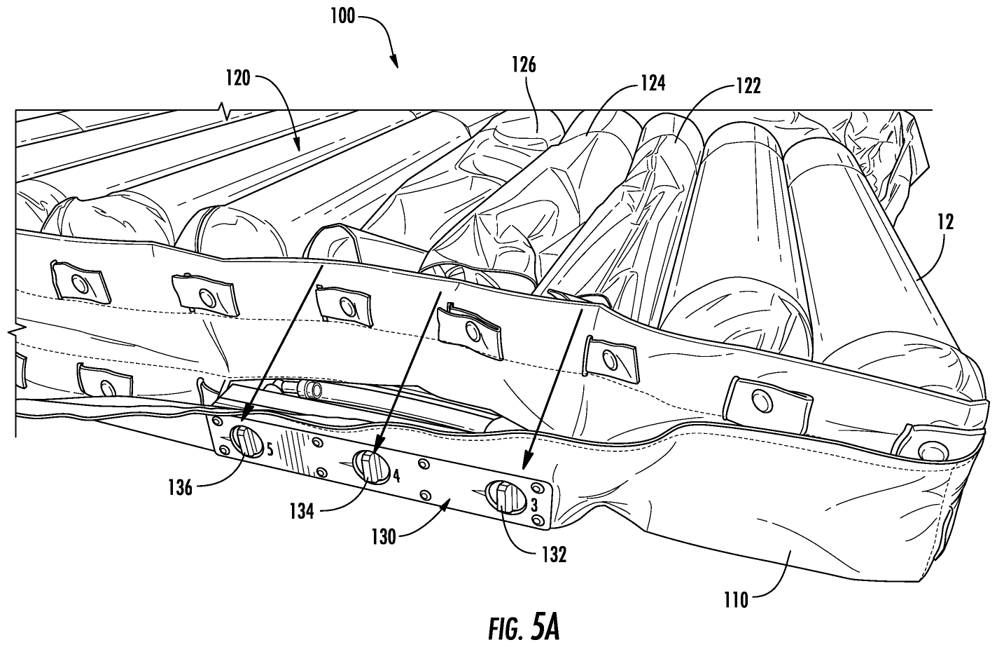

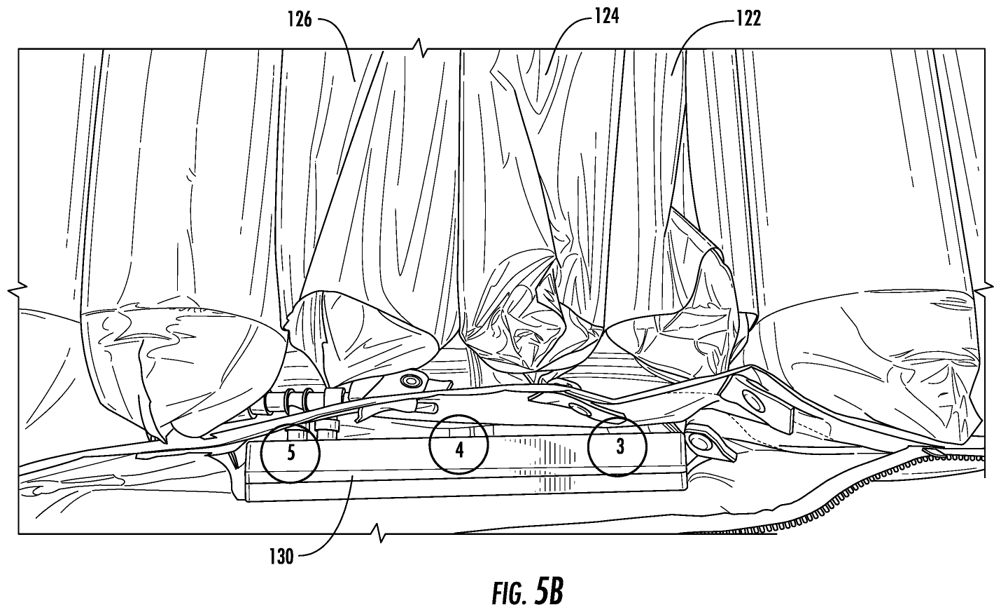

FIGS. 5A and 5B illustrate perspective views of the selective air cell control for the patient support mattress with three air cells in the deflated configuration. Specifically, FIGS. 5A and 5B illustrate the third air cell 122 connected to the first selector switch 132 and the third air cell 122 in the deflated configuration with the first selector switch 132 of the selective air cell control mechanism 130 in the deflated position. Additionally, the fourth air cell 124 connected to the second selector switch 134 is in the deflated configuration with the second selector switch 134 of the selective air cell control mechanism 130 in the deflated position. Lastly, the fifth air cell 126 connected to the third selector switch 136 is in the deflated configuration with the third selector switch 136 of the selective air cell control mechanism 130 in the deflated position.

While FIGS. 3A and 3B illustrate one air cell in a deflated configuration and FIGS. 4A and 4B illustrate two air cells in the deflated configuration and FIGS. 5A and 5B illustrate three air cells in the deflated configuration, it should be understood that any combination of these air cells may be deflated/inflated as necessary. For example, the third air cell 132, fourth air cell 134, and fifth air cell 136 may be inflated or deflated individually. In another example, any combination of two air cells of the third air cell 132, fourth air cell 134, and fifth air cell 136 may be inflated or deflated together.

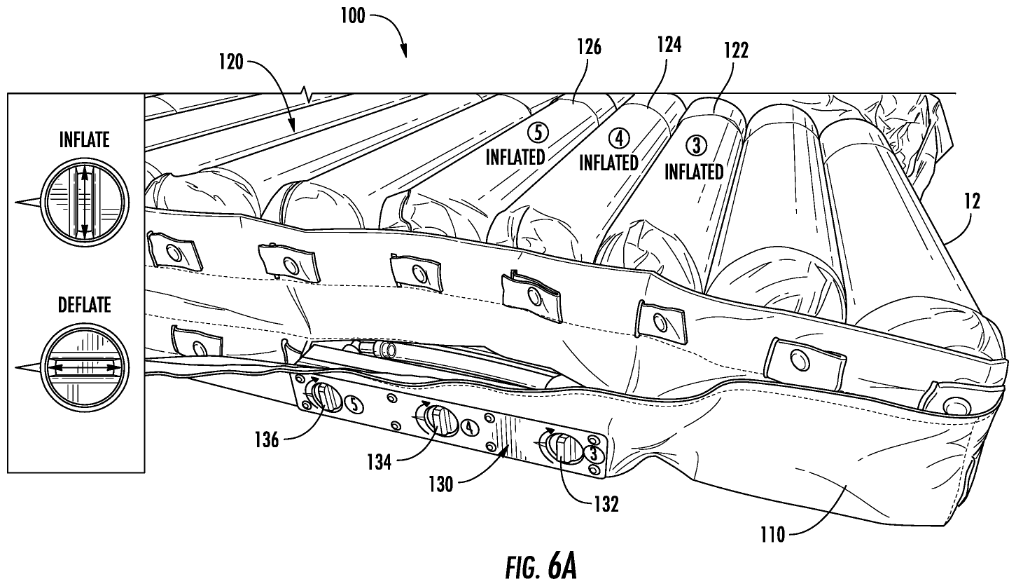

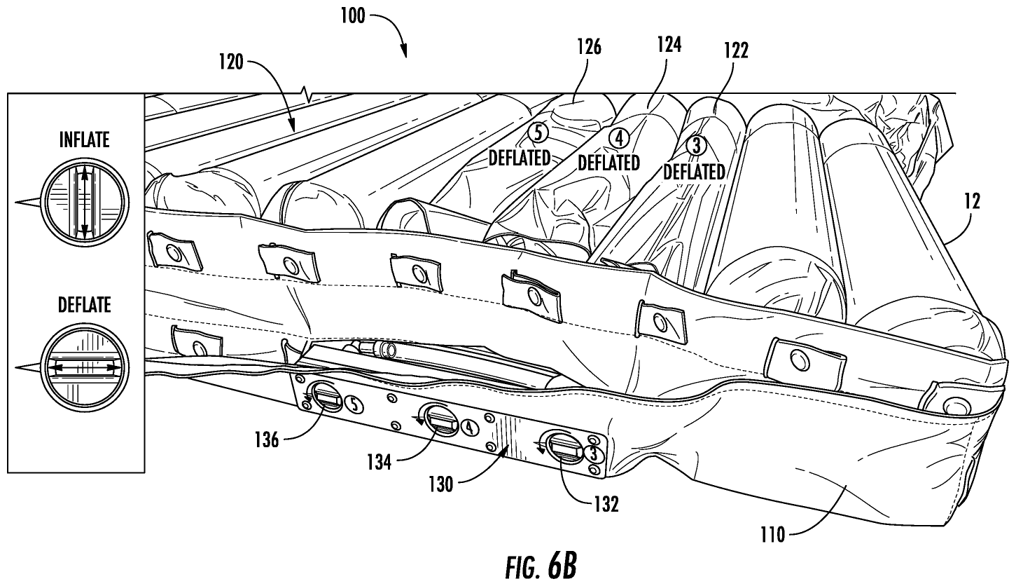

FIG. 6A illustrates a perspective view of a selective air cell control mechanism 130 connected to a plurality of adjacent air cells 122, 124, 126 of the patient support mattress 100 in the inflated configuration. FIG. 6B illustrates a perspective view of the selective air cell control mechanism 130 connected to the plurality of adjacent air cells 122, 124, 126 with the patient support mattress 100 in the deflated configuration. As illustrated in FIGS. 6A and 6B, the selective air cell control mechanism 130 may include one or more switches to inflate and deflate the specific connected air cells 122, 124, 126. Specifically, the one or more switches may be in a vertical position to inflate the air cells 122, 124, 126 or in a horizontal position to deflate the air cells 122, 124, 126.

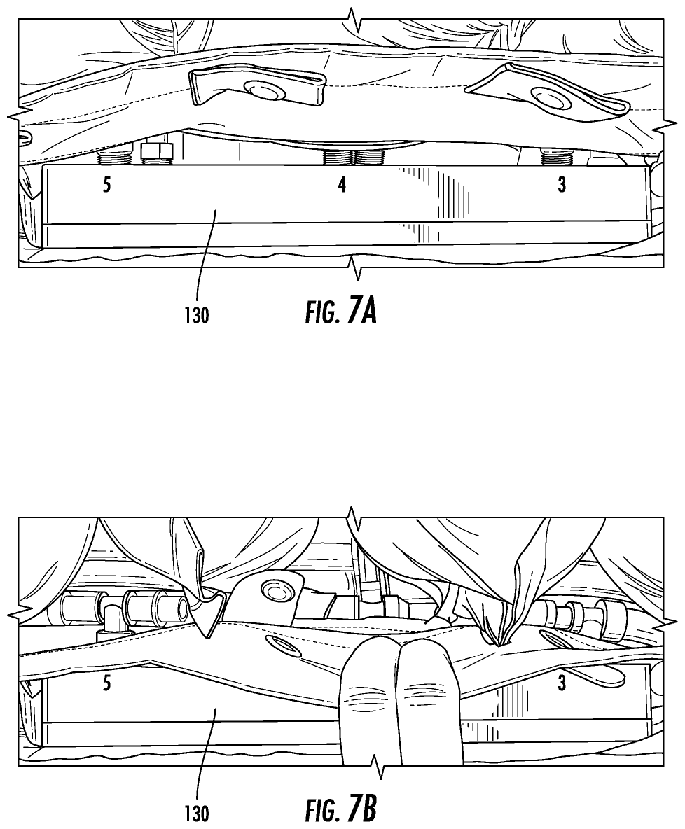

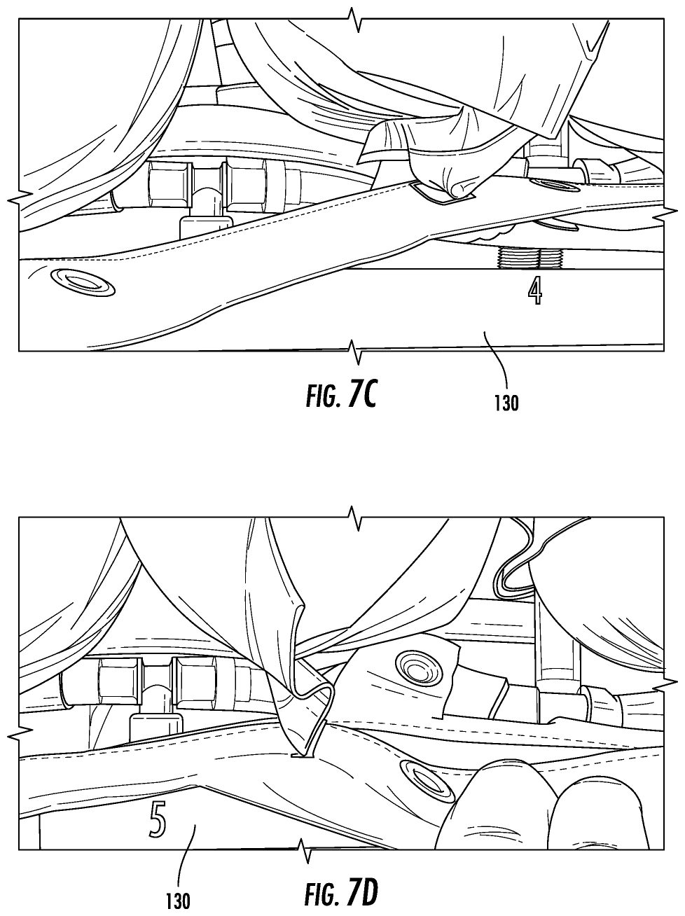

FIGS. 7A, 7B, 7C, 7D, and 7E illustrate close-up views of selective air cell control mechanism 130 connected to a plurality of adjacent air cells 122, 124, 126 of the patient support mattress 100.

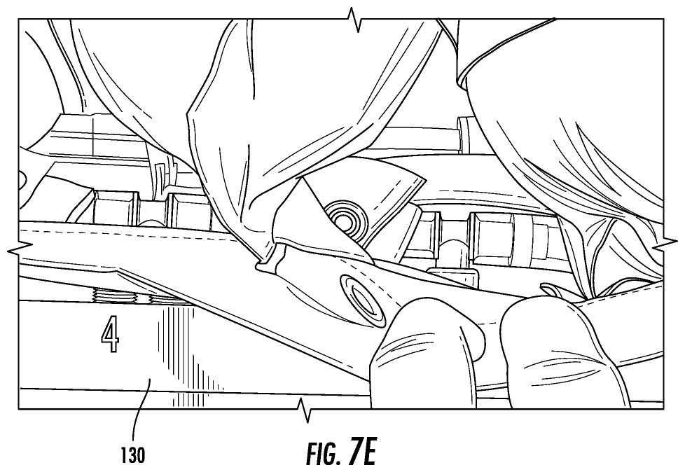

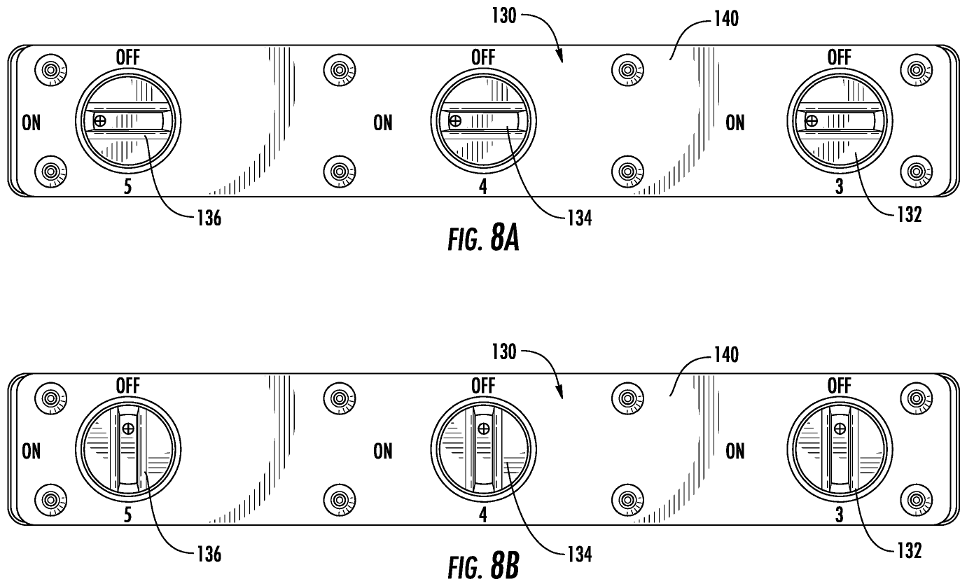

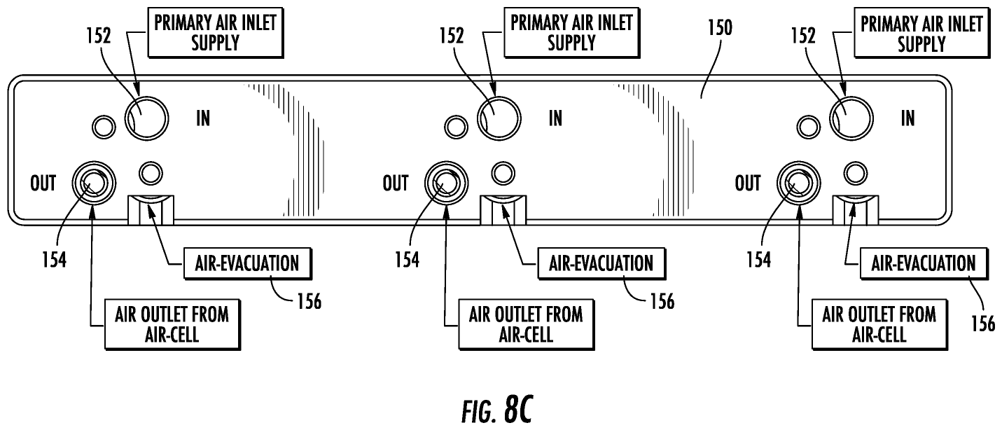

FIGS. 8A and 8B illustrate front views of a front plate 140 to the selective air cell control mechanism 130 may include one or more switches 132, 134, 136 connected to one or more air cells of the patient support mattress 100. Specifically, FIG. 8A illustrates the one or more switches 132, 134, 136 in the ON or INFLATED position and FIG. 8B illustrates the one or more switches 132, 134, 136 in the OFF or DEFLATED position. The switches 132, 134, 136 may be rotational switches as illustrated in the figures. Additionally, the switches 132, 134, 136 may be other switches known and used in the art. The selector switches 132, 134, 136 may be rotated from a first position to a second position. The first position may be an inflated position to fully inflate a single air cell of the patient support mattress 100. The second position may be a deflated position to fully deflate the same single air cell of the patient support mattress 100. Additionally, the switches 132, 134, 136 may be connected to the selective air cell control mechanism 130 and control one or more air cells within the patient support mattress 100. In another embodiment of this invention, the selector switches 132, 134, 136 may include functionality to be rotated to various positions between the inflated position and the deflated position to inflate or deflate the air cells to configurations between the fully inflated position and the fully deflated position.

FIG. 8C illustrates a back view of a back plate 150 to the selective air cell control mechanism 130 connected to the patient support mattress 100. Additionally, FIG. 8C illustrates the back plate 150 that may connect an air supply from the air controller 180 and air outlets to the air cells in the patient support mattress 100. The selective air cell control mechanism 130 may include one or more different air connection ports that each include a primary air inlet supply 152, an air outlet 154 from the air cell mattress 100, and an air evacuation port 156. In an exemplary configuration the selective air cell control mechanism 130 may include three different air connection ports. FIG. 8C illustrates a mechanical valve manifold. The selective air cell control mechanism 130 and invention can also include with an electrical/mechanical valve system. The selective air cell control mechanism 130 may support and be connected to independent air cells, independent zones, or multiple combinations of independent air bladders and/or independent zones.

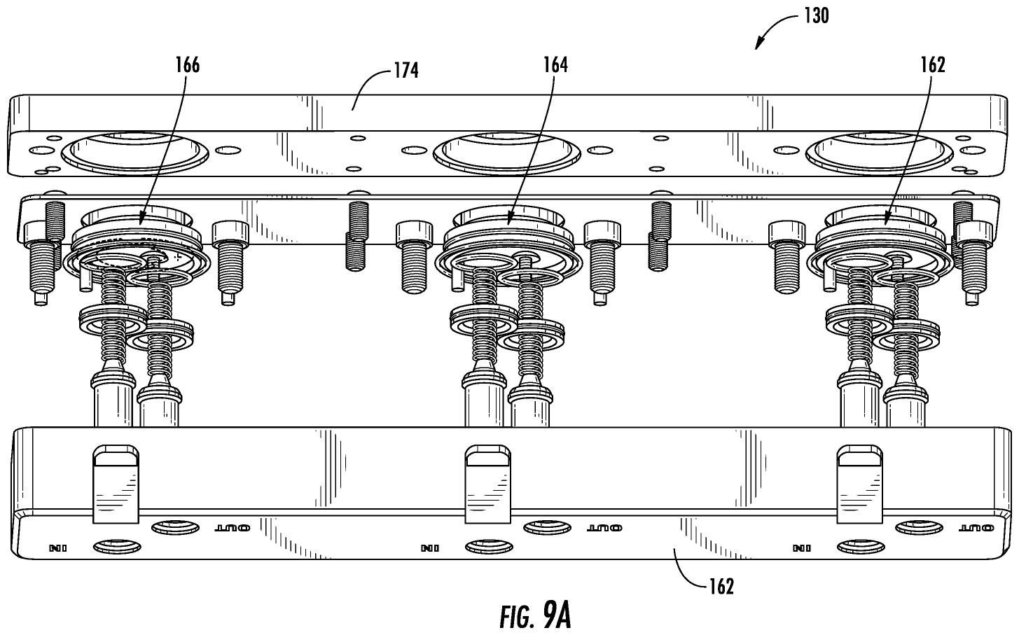

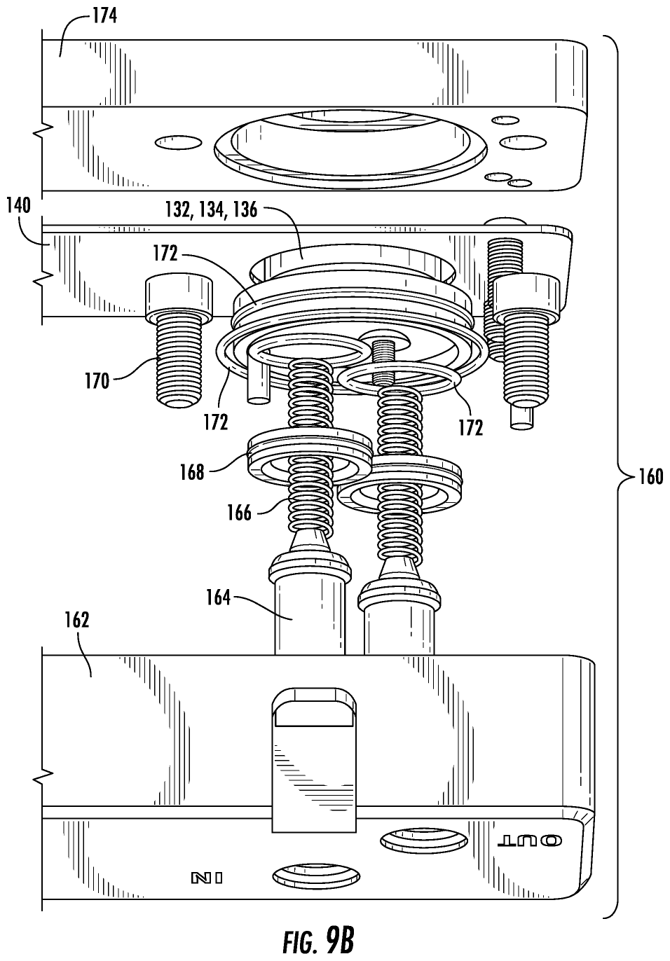

FIG. 9A illustrates an exploded view of the selective air cell control mechanism 130 and specifically one or more air valves 162, 164, 166. FIG. 9B illustrates an exploded view of an air valve assembly 160 of the selective air cell control mechanism 130 connected to the patient support mattress 100. As illustrated in FIG. 9A, the selective air cell control mechanism 130 for the selective air cell control may include one or more different air control valves 162, 164, 166 that correspond to the one or more switches 132, 134, 136. In one exemplary configuration, the selective air cell control mechanism 130 for the selective air cell control may include three different air control valves 162, 164, 166. There may be more or less than three different air control valves 162, 164, 166 as part of the selective air cell control mechanism 130 without departing from this invention. FIG. 9B illustrates an air valve assembly 160 showing each of the potential components of each individual air valve assembly 160. The air valve assembly 160 from the selective air cell control mechanism 130 may include the following parts: a prone housing block 162 to cover the air valve assembly 160, a valve spool 164 to connect the selective air cell control mechanism 130 to one or more of the air hoses of the air cells, one or more valve springs 166, one or more valve seats 168, one or more screws 170, one or more o-rings 172 to ensure a secure air connection between the selective air cell control mechanism 130 and the air cells 122, 124, 126 in the patient support mattress 100, a front plate 140 with a switch or selector 132, 134, 136, and a prone cap block 174.

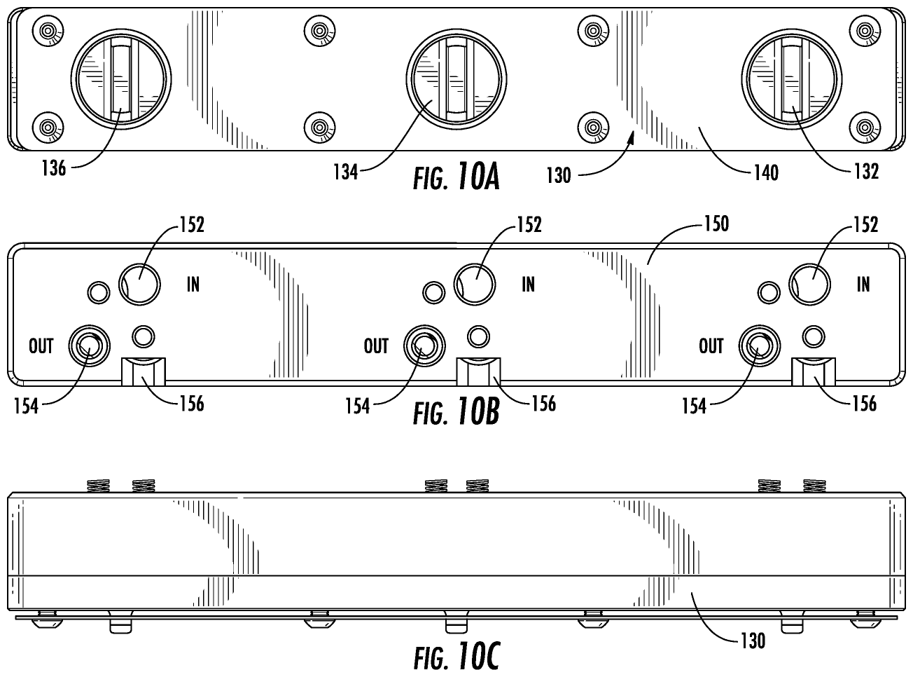

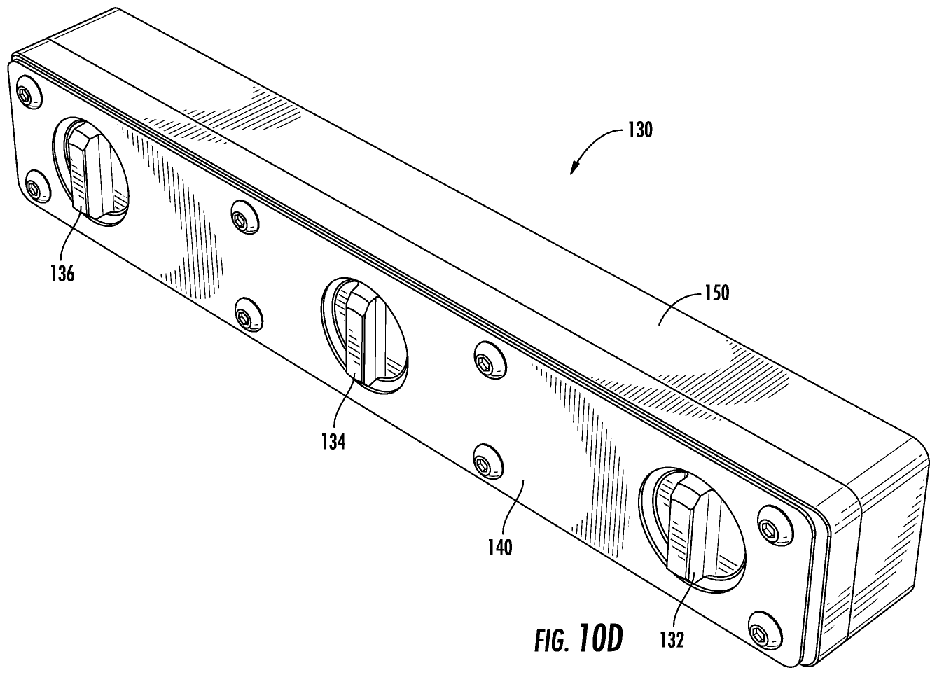

FIGS. 10A, 10B, 10C, and 10D are various views of the selective air cell control mechanism 130 of the patient support mattress 100.

In another embodiment, more than three or less than three air cells may be connected to the selective air cell control mechanism 130. Additionally, air cells at different locations along the patient support mattress 100 may be connected to the selective air cell control mechanism 130 for the selective air cell control, for example to support the trunk, legs, or feet of the patient.

The selective air cell control for a patient support mattress may be activated and deactivated via mechanical switches as illustrated in the figures. In another embodiment, the selective air cell/air bladder control for the patient support mattress may also be activated and deactivated with an electric air control system or air supply control box. The air control system or air supply control box may utilize push buttons. The air control system or air supply control box may also utilize remote controls via buttons on a remote system.

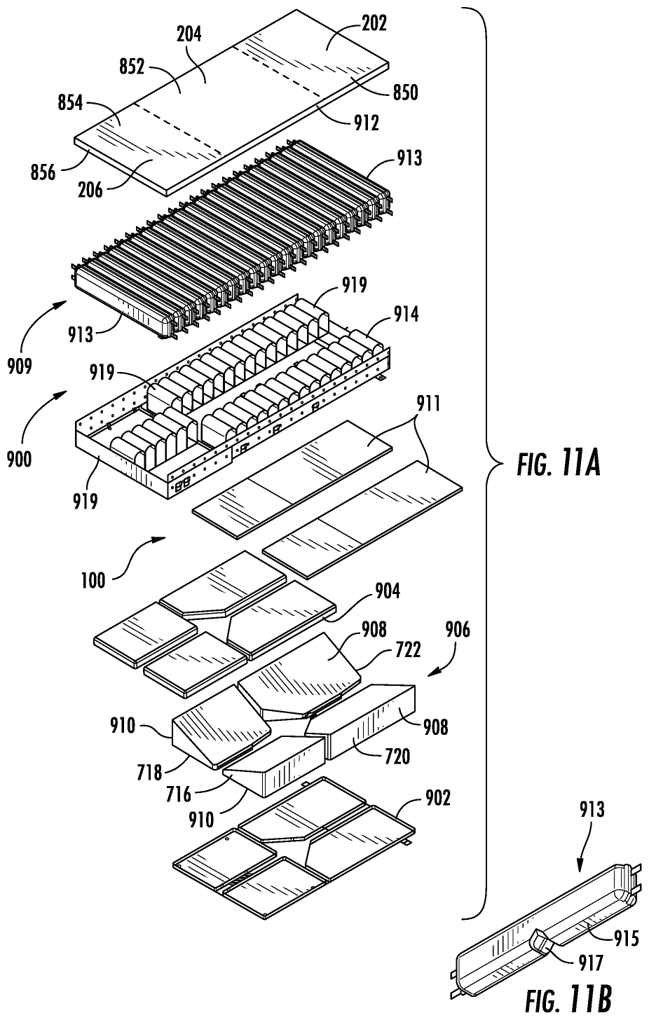

An example patient support mattress 100 for the bed 10 utilized for the selective air cell control is shown in FIG. 11A. One or more portions of the example mattress may be utilized or not utilized in coordination with the selective air cell control. The patient support mattress 100 of FIG. 11A comprises a closed air-cell mattress, however, other mattress with additional or fewer capabilities may be employed. The patient support mattress 100 is provided on the deck plates of the head deck, seat deck and foot deck sections 202, 204, 206. Though the patient support mattress 100 is a single component in many embodiments, it will be identified as having a head mattress portion 850, a seat mattress portion 852 and a foot mattress portion 854. For example, in one embodiment the head and seat mattress portions 850, 852 may be connected together and the foot mattress portion 854 may be separated. The head and seat mattress portions 850, 852 may be connected to the head and seat deck sections 202, 204, and the separate foot mattress portion 854 may be connected to the foot deck section 206. Additionally, the patient support mattress 100 includes an encasing 856 that generally covers and/or encloses the entire patient support mattress 100, or multiple encasings may be provided to cover different sections of the mattress, and the encasing(s) may be strapped or otherwise connected to the various sections of the bed 10. In an alternate mattress, the patient support mattress 100 may comprise a combination of air and foam sections and inserts.

Referring to FIG. 11A, the patient support mattress 100 may include a low air loss mattress 900 with rotational capabilities. This mattress may provide dynamic alternating pressure capabilities. Dynamic alternating pressure capabilities may be achieved by alternately inflating and deflating different air cells periodically. In one embodiment, structure for rotational capabilities of the low air loss mattress 900 comprises a bottom encasement 902 that mates with a top encasement 904 to enclose a turning bladder kit 906. The turning bladder kit provides two independent turning bladders 908 for the head section 202 (one for each side of the head section) of the bed, and two independent turning bladders 910 for the seat section 204 of the bed (one for each side of the seat section). The bladders include a first side seat rotation bladder 716, a second side seat rotation bladder 718, a first side head rotation bladder 720 and a second side head rotation bladder 722. In one embodiment the cross-sectional geometry of the rotation bladders is generally circular. In an alternate embodiment the cross-sectional geometry of the rotation bladders is generally triangular such that the tall portion of the rotation bladder is toward the edge of the patient support deck and the portion of the rotation bladder that approaches the baseline is toward the middle of the patient support deck. The top encasement 904 is zippered to the bottom encasement 902. Further, a plurality of independent low air loss and alternating pressure mattress sections 913 are provided as a low air loss and alternating pressure bladder system 909 within a top and bottom encasement 912, 914. The low air loss and alternating pressure bladder system 909 is preferably positioned above the rotation portions of the mattress. In one embodiment, the low air loss and alternating pressure mattress sections 913 comprise independent mattress sections that extend the width of the bed. In one embodiment, the mattress sections 913 have a foam member (not shown) placed inside a bladder 915 filled with air as shown in FIG. 11B. Further, in one embodiment, preferably located at the head and seat sections where rotation may be utilized, the foam member may be split into two separate foam members, with a gap between the two foam members in the middle of the mattress section 913, and the bladder 915 may have a notch 917 to facilitate easy rotation of the mattress section 913 at the head and seat sections. Generally, however, if no rotation is provided at the foot section, the foam members within the mattress sections 913 at the foot section of the bed may unitary and extend from one side of the mattress section 913 to the other side of the mattress section 913 without any break or gap. The mattress sections 913 in the foot deck may have two notches, similar to notch 917 shown in FIG. 11B. The air cell sections 913 may be supported in the bottom encasement 914 with retaining loops 919.

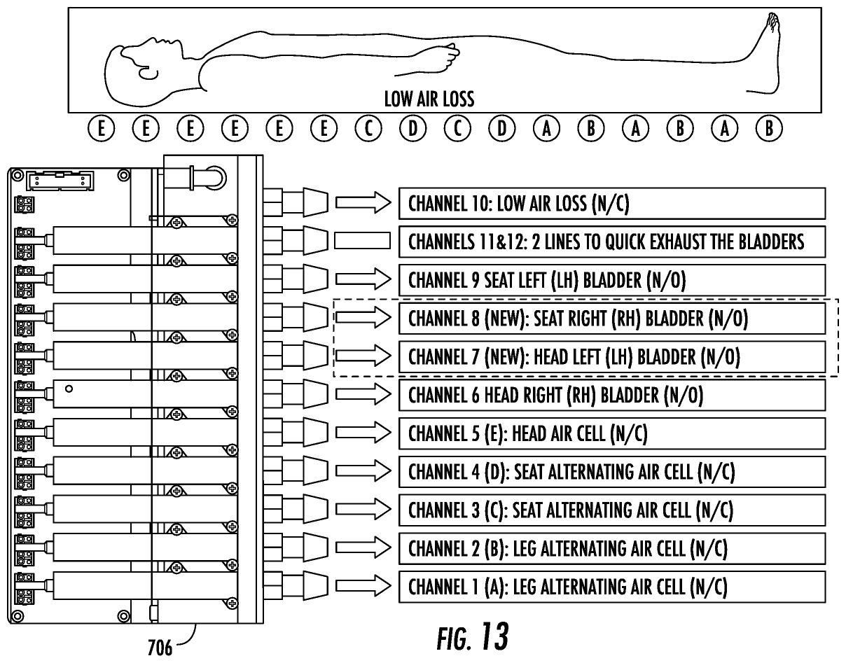

Referring to FIG. 11A, an optional foam support 911, preferably with a plastic backing, may be provided above the top encasement 904 to support the air cell sections 913 of the low air loss and alternating pressure portion of the mattress. In one embodiment, the foam support 911 comprises separate or hingeable head and seat sections for each side of the bed. The low air loss and alternating pressure bladder system 909 is provided in a top and bottom encasement 912, 914 above the top encasement 904 of the rotational bladders and above the foam supports 911. In one embodiment, as show in FIG. 13, the alternating bladder system 909 includes six bladders 913 in the head section 202 of the mattress and each extending from one side of the mattress to the opposite side of the mattress, four bladders 913 in the seat section 204 of the mattress and each extending from one side of the mattress to the opposite side of the mattress, and six bladders 913 in the foot section 206 of the mattress and each extending from one side of the mattress to the opposite side of the mattress. Additionally, in one embodiment the bottom encasement 914 comprises a manifold system to provide air to each of the mattress section 913 bladders of the mattress. In one embodiment, each separate mattress section 913 has fasteners to maintain each mattress section 913 in the proper orientation within the top and bottom encasement 912, 914, and the mattress encasement 912, 914 is fixed with fasteners to the patient support platform.

In one embodiment, the seat and foot sections of the alternating pressure mattress each have two zones, an A and B zone in the foot section, and a C and D zone in the seat section (see FIG. 13). This allows for alternating bladders 913 in each of the seat and foot sections to be inflated and deflated providing therapeutic benefit to the patient. Accordingly, in the mattress of FIG. 13 there are five zones for alternating pressure in the air bladders 913 of this mattress: one zone for the air bladders 913 in the head section, two zones for the air bladders 913 in the seat section and two zones for the air bladders 913 in the foot section.

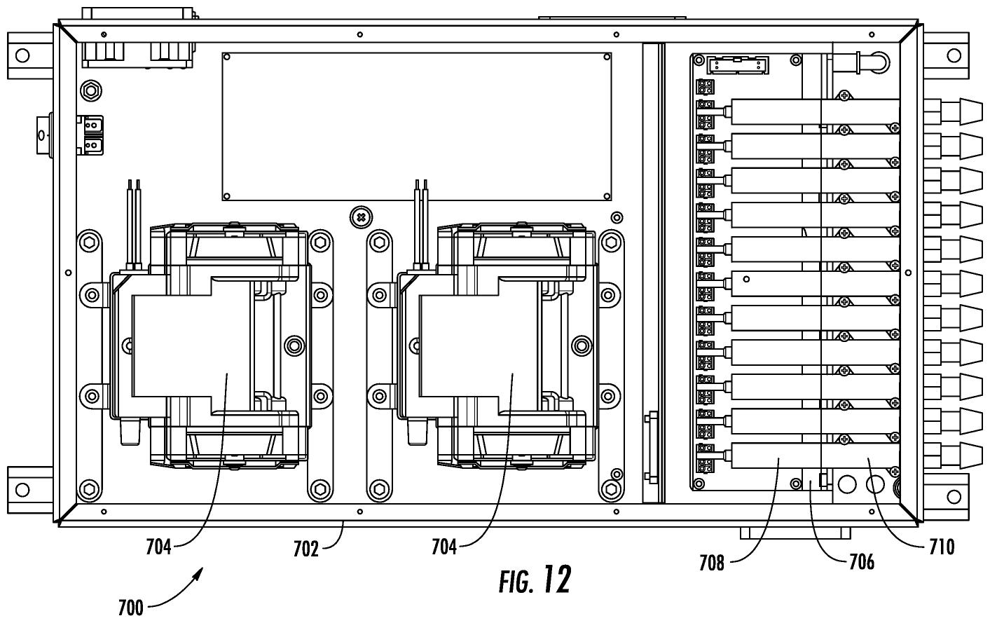

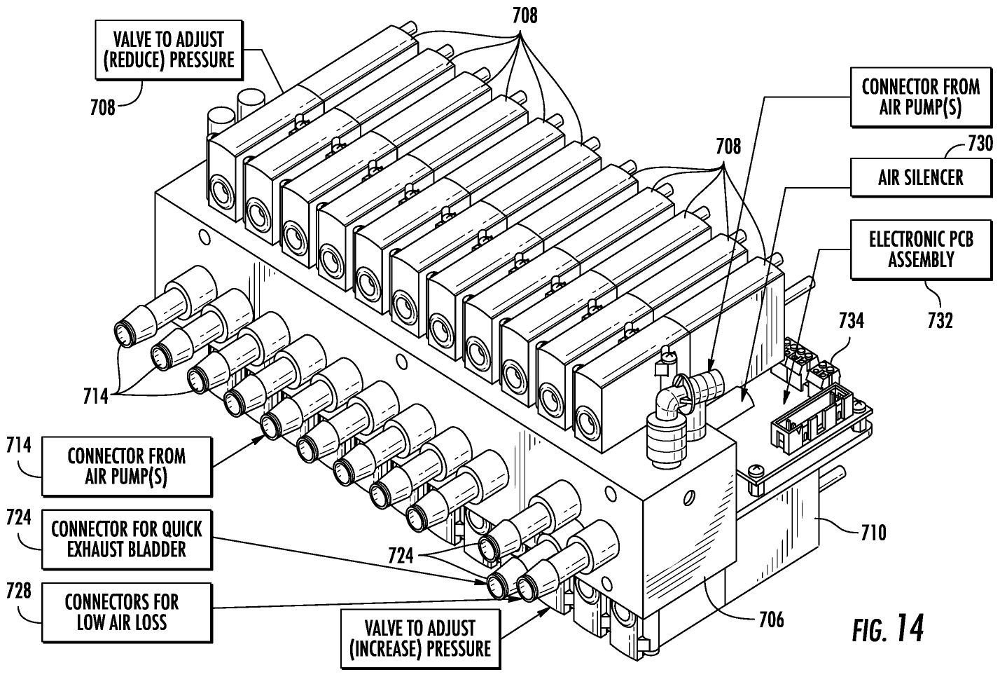

In one embodiment, when the bed 10 has air bladders, and particularly air bladders for patient support surfaces, the bed 10 may include an air supply control box 180, 700 as shown in FIG. 12. Referring to FIG. 12 there is shown an enclosure 702 that houses pumps 704, a main manifold 706 and a plurality of valves 708, 710. As shown in FIG. 12, two pumps 704 are provided in a preferred embodiment to provide additional volume of air for quicker inflation and deflation of the air bladders, however, in alternate embodiments only one pump is provided. Air from the pumps enters the manifold 706 at the input fitting 712 (see also FIG. 14). The manifold has numerous outputs. As shown in FIG. 14, in one embodiment there are nine air bladder fitting 714 outputs. The nine outputs are for: (a) the air bladder zones in the head section (one zone), seat section (2 zones), foot section (2 zones)—which in total occupy 5 of the fittings 714; and, (b) the rotation bladders, including the first side seat rotation bladder 716, second side seat rotation bladder 718, first side head rotation bladder 720 and second side head rotation bladder 722 (see also FIG. 11)—which in total occupy 4 of the fittings 714. Next to the air bladder fittings 714 are quick exhaust bladder fittings 724 which are utilized to assist in deflating air cells more quickly by passing air to be drawn out of a specific bladder to the CPR manifold 726 that has quick exhaust valves. Finally, the last output fitting 728 is for the low air loss aspect of the mattress which bleeds air within the encasement of the mattress to allow the air to escape for therapeutic purposes. The main manifold 706 may also have an air silencer 730, which operates essentially as a muffler for air exhausting out of the manifold 706 that is not being quick released through the CPR manifold 726. In one embodiment, each of the nine air bladder output fittings 714 and the quick release exhaust bladder fittings 724 have a separate first valve 708 associated therewith to allow for adjusting the air pressure in the specific bladder/cell by reducing the air pressure in that specific bladder/cell. Accordingly, in a preferred embodiment there are ten first valves 708. Additionally, each of the nine air bladder output fittings 714, the quick release exhaust fittings 724 and the low air loss fitting 728 have a separate second valve 710 associated therewith to allow for adjusting the air pressure in the specific bladder/cell/low air loss area by increasing the air pressure to that specific bladder/cell/low air loss area. Accordingly, in a preferred embodiment there are eleven second valves 710.

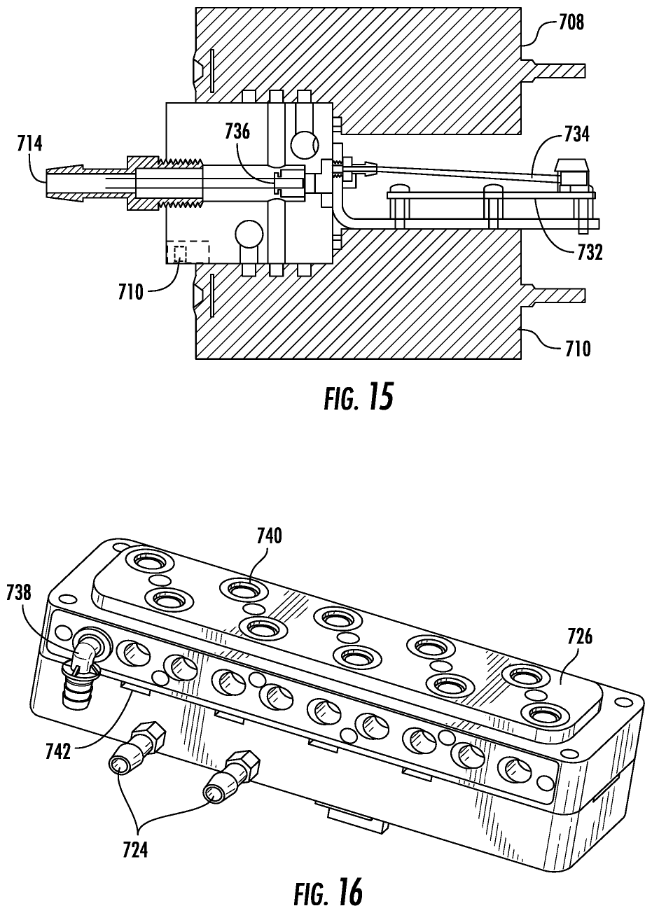

The manifold 706 also has a mother board or PCB 732 (see FIGS. 14 and 15), on which there are, among other things, pressure sensors 734 for each output fitting. The pressure in each specific bladder/cell/low air loss area is determined by sensing the pressure within each respective output tube connected to each respecting output fitting with a separate smaller diameter tube (not shown) being inside that output tube. The smaller tubes connect to separate connectors 736 inside the manifold 706 (see the cross-sectional view of FIG. 15), which in turn are fluidly connected to the respective separate sensors 734 on the PCB 732.

In addition to the main manifold 706, in one embodiment a CPR manifold 726 is provided for rapidly dumping air from the various air bladders. Referring to FIG. 16, the CPR manifold 726 is provided in line between the main manifold 706 and the air mattress 22. Accordingly, tubes connect the appropriate output fittings on the main manifold 706 with respective connectors 738 on the CPR manifold 726 (note that not all of the respective connectors 738 are shown in FIG. 16). Further individual output fittings are then connected to the openings 740 on the top of the CPR manifold 726 to connect to each specific bladder/cell/low air loss area. The CPR manifold 726 also has a plurality of exhaust breath ways 742 to rapidly exhaust air out of any bladder/cell.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention.

We claim:

1. A patient support mattress comprising:
a plurality of air segments at a head section of the patient support mattress that includes one or more individual horizontal air segments supporting a head portion of a body of a patient; and
an air control mechanism connected to the one or more individual horizontal air segments, wherein the air control mechanism selectively deflates each of the one or more individual air segments in the plurality of air segments.

2. The patient support mattress from claim 1, wherein the one or more individual horizontal air segments include a plurality of adjacent individual air segments.

3. The patient support mattress from claim 2, wherein the plurality of adjacent individual air segments includes three adjacent individual air segments that are located at a third horizontal position, a fourth horizontal position, and a fifth horizontal position counting the plurality of air segments starting from the head portion of the patient support mattress.

4. The patient support mattress from claim 1, wherein each of the plurality of air segments extend horizontally from a first side of the patient support mattress to an opposite second side of the patient support mattress.

5. The patient support mattress from claim 1, wherein the air control mechanism includes one or more selector switches with each selector switch connected to one of the individual horizontal air segments to allow a user to manually selectively control inflating and deflating the individual horizontal air segments.

6. The patient support mattress from claim 5, wherein the one or more selector switches are rotational switches, rotating from a first position for inflating the individual horizontal air segments to a second position for deflating the individual horizontal air segments.

7. The patient support mattress from claim 1, wherein the air control mechanism includes one or more air valve assemblies with each air valve assembly connected to one of the individual horizontal air segments to selectively control inflating and deflating the individual horizontal air segments.

8. The patient support mattress from claim 7, wherein each air valve assembly includes an air control valve, a valve spool to connect the air valve assembly to the individual horizontal air segments, and one or more o-rings to ensure a secure air connection between the air control mechanism and the individual horizontal air segments of the patient support mattress.

9. The patient support mattress from claim 1, wherein the air control mechanism includes an electric air control system to electrically activate and deactivate the air control mechanism and provide selective air segment control for deflating and inflating the individual horizontal air segments of the patient support mattress.

10. The patient support mattress from claim 9, wherein the electric air control system includes a remote control with a plurality of buttons to remotely activate and deactivate the air control mechanism and provide selective air segment control for deflating and inflating the individual horizontal air segments of the patient support mattress.

11. The patient support mattress from claim 1, wherein the air control mechanism includes an air inlet supply port connected to the individual horizontal air segments, an air outlet port connected to an air control system that provides air to the plurality of air segments, and an air evacuation port.

12. A patient support mattress comprising:
a plurality of air segments at a head section of the patient support mattress that includes three adjacent individual air segments supporting a head portion of a body of a patient, the three adjacent individual air segments extending horizontally across the patient support mattress, with a first individual air segment located at a third horizontal position, a second individual air segment located at a fourth horizontal position, and third individual air segment located at a fifth horizontal position counting the plurality of air segments starting from the head portion of the patient support mattress; and
a selective air control mechanism connected to the three adjacent individual air segments of the plurality of air segments,
the selective air control mechanism includes one or more selector switches with each selector switch connected to one of the adjacent individual air segments to manually selectively control inflating and/or deflating the three adjacent individual air segments.

13. The patient support mattress from claim 12, wherein each of the plurality of air segments extend horizontally from a first side of the patient support mattress to an opposite second side of the patient support mattress.

14. The patient support mattress from claim 12, wherein the selective air control mechanism includes one or more air valve assemblies with each air valve assembly connected to one of the three adjacent individual air segments to selectively control inflating and deflating the three adjacent individual air segments.

15. The patient support mattress from claim 14, wherein each air valve assembly includes an air control valve, a valve spool to connect the air valve assembly to the adjacent individual air segments, and one or more o-rings to ensure a secure air connection between the selective air control mechanism and the adjacent individual air segments of the patient support mattress.

16. The patient support mattress from claim 12, wherein the selective air control mechanism includes an air inlet supply port connected to the adjacent individual air segments, an air outlet port connected to an air control system that provides air to the plurality of air segments, and an air evacuation port.

17. A patient support mattress comprising:
a plurality of air cells that includes three adjacent individual air cells located at a head portion of the patient support mattress on a patient bed, the three adjacent individual air cells supporting a head portion of a body of a patient, with a first individual air cell located at a third horizontal position, a second individual air cell located at a fourth horizontal position, and third individual air cell located at a fifth horizontal position counting the plurality of air cells starting from the head portion of the patient support mattress; and
a selective air control mechanism connected to the three adjacent individual air cells,
wherein the selective air control mechanism includes an electric air control system with a plurality of buttons to electrically activate and deactivate the selective air control mechanism and provide selective air cell control for deflating and/or inflating the adjacent individual air cells of the patient support mattress.

18. The patient support mattress from claim 17, wherein each of the plurality of individual air cells extend horizontally from a first side of the patient support mattress to an opposite second side of the patient support mattress.

19. The patient support mattress from claim 17, wherein the selective air control mechanism includes one or more air valve assemblies with each air valve assembly connected to one of the adjacent individual air cells to selectively control inflating and deflating the adjacent individual air cells.

20. The patient support mattress from claim 19, wherein each air valve assembly includes an air control valve, a valve spool to connect the air valve assembly to the adjacent individual air cells, and one or more o-rings to ensure a secure air connection between the selective air control mechanism and the adjacent individual air cells of the patient support mattress.
